(19) United States
(12) Patent Application Publication
(10) Pub. No.: US 2024/0399588 A1
(43) Pub. Date: Dec. 5, 2024

(54) POSITION AND POSTURE MEASUREMENT SYSTEM

(71) Applicant: FANUC CORPORATION, Yamanashi (JP)

(72) Inventors: Shoutarou OGURA, Yamanashi (JP); Yuta NAMIKI, Yamanashi (JP); Kyouhei KOKUBO, Yamanashi (JP)

(73) Assignee: FANUC CORPORATION, Yamanashi (JP)

(21) Appl. No.: 18/694,250

(22) PCT Filed: Sep. 30, 2021
(86) PCT No.: PCT/JP2021/036257

§ 371 Date: Mar. 21, 2024

(51) Int. Cl. B25J 9/16; G06T 7/70; G06T 7/80

(52) U.S. Cl. CPC B25J 9/1697; G06T 7/70; G06T 7/80

(57) ABSTRACT

Provided is a system that is capable of accurately measuring the three-dimensional position and posture of an object under measurement with simple teaching and in a short measurement time. A position and posture measurement system according to the present invention is provided with: a vision sensor that has already been calibrated; a position and posture moving unit that is capable of moving the three-dimensional position and posture of an object under measurement or the vision sensor; a calibration-data storage unit; an image processing unit that processes a captured image of the object under measurement; a position and posture measurement unit that measures the three-dimensional position and posture of the object under measurement by using the result of the image processing; an image-capturing-position correction unit that executes correction processing at least once, the correction processing being processing in which the vision sensor or the object under measurement is moved by the position and posture moving unit by using the measured three-dimensional position and posture and in which the image processing and the measurement of the three-dimensional position and posture are then sequentially carried out; and an image-capturing-position correction termination unit that executes the correction processing again upon determining that the correction processing is not to be terminated, while adopting the three-dimensional position and posture calculated either the last or in the middle as a three-dimensional position and posture to be used for robot control upon determining that the correction processing is to be terminated.

### TECHNICAL FIELD

The present disclosure relates to a position and posture measurement system.

### BACKGROUND ART

Conventionally, workpieces have been machined by a robot placed on a transfer device such as a carriage. The robot is transferred to the vicinity of a workpiece by the transfer device, and thereafter, performs various operations such as loading/unloading of the workpiece, replacement of tools, and machining on the workpiece. However, changes in the stop position and stop posture of the robot result in changes in the position and posture of the robot with respect to the workspace. As a consequence, the robot may not be able to appropriately perform operations merely by repeating the same motion every time. For this reason, it is necessary to measure deviations of the position and posture of the robot with respect to the workspace, and to correct the motion of the robot.

For example, a technique has been proposed in which three-dimensional positions of a plurality of reference points arranged in a workspace are detected using a visual sensor attached to a hand or the like of a robot, and an amount of deviation from a reference position or reference posture of the robot set with respect to the workspace is calculated as an amount of correction, thereby correcting the motion of the robot (for example, see Patent Documents 1 and 2).

### CITATION LIST

### Patent Document

Patent Document 1: Japanese Unexamined Patent Application, Publication No. H11-156764
Patent Document 2: Japanese Unexamined Patent Application, Publication No. 2019-093481

### DISCLOSURE OF THE INVENTION

### Problems to be Solved by the Invention

However, the techniques of Patent Documents 1 and 2 have a disadvantage that the three-dimensional position and posture of a measurement target obtained from captured images vary widely, or a disadvantage that since a plurality of measurement targets disposed at a plurality of locations are imaged, a large number of teaching points are present for the imaging position, and a long time is required for teaching and measurement. Therefore, the conventional techniques are not suitable for use in applications in which accurate motion such as mounting of a workpiece is required while a short teaching time and a short measurement time are allowed.

It is an object of the present disclosure to provide a position and posture measurement system capable of accurately measuring three-dimensional position and posture of a measurement target by way of simpler teaching and within a shorter measurement time in comparison with the known art.

### Means for Solving the Problems

One aspect of the present disclosure is directed to a position and posture measurement system for measuring three-dimensional position and posture of a measurement target for use in control of a robot, the position and posture measurement system including: a visual sensor subjected to calibration; a position and posture moving unit that is capable of moving three-dimensional position and posture of the measurement target or three-dimensional position and posture of the visual sensor; a calibration data storage unit that stores in advance calibration data obtained during the calibration of the visual sensor; an image processing unit that processes a captured image of the measurement target, the captured image being obtained by imaging the measurement target by the visual sensor; a position and posture measurement unit that measures three-dimensional position and posture of the measurement target by using a result of image processing by the image processing unit; an imaging position correction unit that performs correction processing at least once, the correction processing including causing the position and posture moving unit to move the visual sensor or the measurement target by using the three-dimensional position and posture of the measurement target measured by the position and posture measurement unit, followed by sequentially causing the image processing unit to perform image processing, and the position and posture measurement unit to perform measurement; and an imaging position correction termination unit that determines whether or not to terminate the correction processing by the imaging position correction unit, wherein when determining that the correction processing is not to be terminated, the imaging position correction termination unit causes the correction processing to be performed again, and when determining that the correction processing is to be terminated, the imaging position correction termination unit adopts, as the three-dimensional position and posture of the measurement target for use in control of the robot, three-dimensional position and posture of the measurement target obtained through a final measurement or a halfway measurement by the position and posture measurement unit.

### Effects of the Invention

One aspect of the present disclosure provides the position and posture measurement system capable of accurately measuring three-dimensional position and posture of a measurement target by way of simpler teaching and within a shorter measurement time in comparison with the known art.

### BRIEF DESCRIPTION OF THE DRAWINGS

FIG. 1 is a diagram illustrating a configuration of a robot system according to a first embodiment;

FIG. 2 is a block diagram illustrating a configuration of a position and posture measurement system according to the first embodiment;

FIG. 3 is a flowchart illustrating a procedure of processing performed by the position and posture measurement system according to the first embodiment;

FIG. 4 is a diagram illustrating changes in input images in a case where an imaging position is moved;

FIG. 5 is a diagram illustrating a position of a measurement target before movement of an imaging position and a position of the measurement target at the time of setting a reference position;

FIG. 6 is a diagram illustrating a position of the measurement target after the movement of the imaging position and the position of the measurement target at the time of setting the reference position;

FIG. 7 is a flowchart illustrating a procedure of processing performed by a position and posture measurement system according to a modification of the first embodiment;

FIG. 8 is a block diagram illustrating a configuration of a position and posture measurement system according to a second embodiment;

FIG. 9 is a diagram illustrating changes in input images in a case where an imaging position is moved and luminance is adjusted;

FIG. 10 is a block diagram illustrating a configuration of a position and posture measurement system according to a third embodiment;

FIG. 11 is a diagram illustrating a display screen of an interface device in a case where a difference in luminance of a measurement target between images before and after movement of an imaging position is determined to be greater than a second threshold value;

FIG. 12 is a block diagram illustrating a configuration of a position and posture measurement system according to a fourth embodiment; and

FIG. 13 is a diagram illustrating a display screen of an interface device in a case where an undetectable range in an input image after movement of an imaging position is determined to be greater than an undetectability threshold value.

### PREFERRED MODE FOR CARRYING OUT THE INVENTION

Embodiments of the present disclosure will be described below with reference to the drawings. In the description of each embodiment, the same components as those of a first embodiment will be denoted by the same reference numerals, and the description thereof will be omitted as appropriate.

### First Embodiment

A position and posture measurement system according to the first embodiment of the present disclosure measures three-dimensional position and posture (X, Y, Z, W, P, R) of a measurement target for use in control of motion of a robot, by using an image of the measurement target captured by a calibrated visual sensor and calibration data. More specifically, the position and posture measurement system according to the first embodiment makes correction that brings a relative position of a current imaging position and the measurement target close to a relative position of an imaging position and the measurement target at the time of setting a reference position of the robot, thereby making it possible to reduce variation in measurement in comparison with a case where the correction is not made and enabling more accurate measurement of the three-dimensional position and posture of the measurement target than the known art.

The reference position of the robot as used herein refers to a position serving as the reference based on which the correction is made. A difference between a position (reference position) of the measurement target at the time of setting the reference position of the robot and a position of the measurement target at the time of the correction is calculated, and motion to be corrected is multiplied by the difference, thereby completing the correction. The difference is represented by a homogeneous transformation matrix, and the corrected position is obtained by multiplying a three-dimensional position (vector) by the homogeneous transformation matrix. The same correction can be made by storing a three-dimensional position of the measurement target at the time of setting the reference position, teaching motion of the robot based on the stored position serving as a reference coordinate system, and rewriting the coordinate system using a position of the target at the time of measurement.

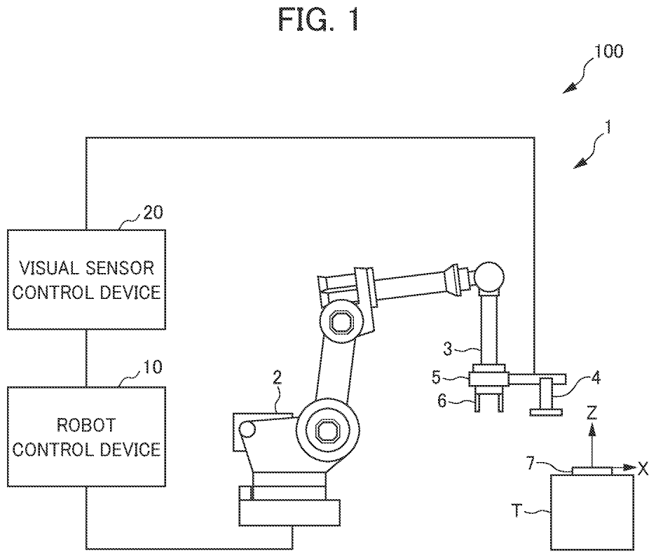

FIG. 1 is a diagram illustrating a configuration of a robot system 100 according to the first embodiment. As illustrated in FIG. 1, the robot system 100 includes a position and posture measurement system 1 according to the first embodiment. The robot system 100 includes a robot 2, a visual sensor 4, a visual sensor control device 20, a robot control device 10, and a measurement target 7. For example, the robot system 100 recognizes three-dimensional position and posture of a workpiece based on, for example, an image of the workpiece captured by the visual sensor 4, and performs a predetermined operation such as handling or machining of the workpiece.

The robot 2 has a robot arm 3 and an end tool 6 attached to a distal end portion of the robot arm 3 via a flange 5. The robot 2 performs a predetermined operation such as handling or machining of the workpiece under the control of the robot control device 10. The visual sensor 4 is attached to a distal end portion of the robot arm 3 of the robot 2 via the flange 5. Due to this configuration, the three-dimensional position and posture of the visual sensor 4 can be moved.

The visual sensor 4 is controlled by the visual sensor control device 20, and captures an image of the measurement target 7 such as a workpiece, a calibration jig, and a marker. The visual sensor 4 is a calibrated visual sensor. Examples of the visual sensor 4 include a general two-dimensional camera and a three-dimensional camera such as a stereo camera.

The visual sensor control device 20 controls the visual sensor 4 and processes an image captured by the visual sensor 4. Furthermore, the visual sensor control device 20 detects three-dimensional position and posture of the measurement target 7 from the image captured by the visual sensor 4.

The robot control device 10 executes a motion program for the robot 2 to control the motion of the robot 2. At this time, the robot control device 10 corrects the motion of the robot 2 based on the three-dimensional position and posture of the measurement target 7 detected by the visual sensor control device 20, and thereby causes the robot 2 to perform a predetermined operation.

When the visual sensor 4 captures an image, the robot control device 10 controls the position and posture of the robot 2 so as to control the position and posture of the visual sensor 4. Thus, the robot control device 10 controls the relative position of the measurement target 7 and the visual sensor 4 by controlling the position and posture of the visual sensor 4 with respect to the position and posture of the measurement target 7 that are stationary.

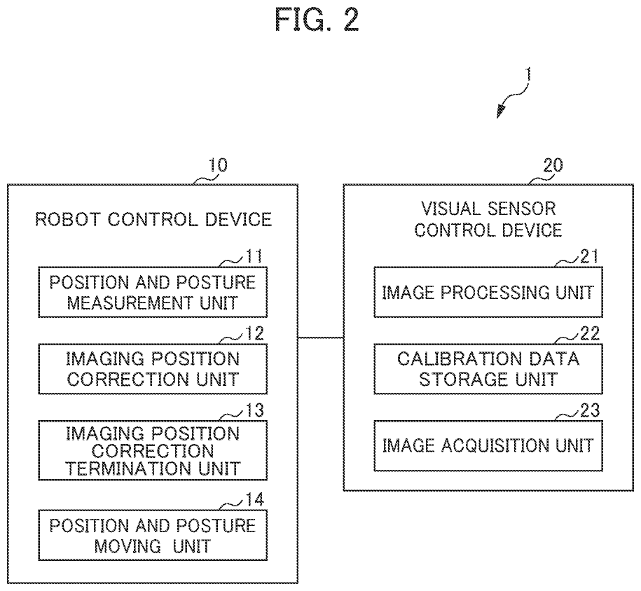

FIG. 2 is a block diagram illustrating a configuration of the position and posture measurement system 1 according to the first embodiment. As illustrated in FIG. 2, the position and posture measurement system 1 according to the first embodiment includes the visual sensor control device 20 and the robot control device 10. The visual sensor control device 20 includes an image processing unit 21, a calibration data storage unit 22, and an image acquisition unit 23. The robot control device 10 includes a position and posture measurement unit 11, an imaging position correction unit 12, an imaging position correction termination unit 13, and a position and posture moving unit 14.

The image acquisition unit 23 acquires an image captured by the visual sensor 4 as an input image. The image acquisition unit 23 transmits the acquired input image to the image processing unit 21.

The image processing unit 21 processes the input image transmitted from the image acquisition unit 23. More specifically, the image processing unit 21 uses, for example, a model pattern stored in advance, and detects the measurement target 7 from the input image when a detection score based on a degree of match with the model pattern is equal to or greater than a predetermined threshold value. Furthermore, the image processing unit 21 obtains three-dimensional position and position of the measurement target 7 relative to the visual sensor 4, from the input image and calibration data stored in the calibration data storage unit 22, which will be described later.

The principle of obtaining the three-dimensional position and posture of the measurement target 7, such as the calibration jig, relative to the calibrated visual sensor 4 from the positional information regarding the measurement target 7 in the input image captured by the calibrated visual sensor 4 is well known from, for example, “Computer Vision: Technical Criticism and Future Prospect” written by Takashi MATSUYAMA. Specifically, the relative position of the visual sensor 4 and the measurement target 7 is uniquely determined in the case where the following conditions are met: geometric conversion characteristics inside the visual sensor 4 are already known; a geometric relationship between a three-dimensional space in which an object is present and a two-dimensional image plane on which the object is present are already obtained; and a plurality of pairs of pieces of information are obtained one of which indicates a position of a feature such as plural dot points displayed on a calibration jig or the like in a two-dimensional image and the other of which indicates a position of the feature in a three-dimensional space. As such, it is possible to obtain the three-dimensional position and posture of the measurement target 7 relative to the visual sensor 4 as a reference, from the positional information regarding the measurement target 7 in the input image captured by the calibrated visual sensor 4.

The image processing unit 21 belonging to the visual sensor control device 20, and the robot control device 10 are each constituted by, for example, an arithmetic processor such as a digital signal processor (DSP) or a field-programmable gate array (FPGA). The functions of the image processing unit 21 belonging to the visual sensor control device 20 and the functions of the robot control device 10 are implemented by executing predetermined software (program, application), for example. The functions of the image processing unit 21 belonging to the visual sensor control device 20 and the functions of the robot control device 10 may be implemented by cooperation of hardware and software, or may be implemented only by hardware (electronic circuitry).

The calibration data storage unit 22 stores in advance calibration data obtained during the calibration of the visual sensor 4. The calibration data storage unit 22 belonging to the visual sensor control device 20 is constituted by a rewritable memory such as an electrically erasable programmable read-only memory (EEPROM).

The calibration data regarding the visual sensor 4 contains internal parameters and external parameters of the visual sensor 4. Examples of the internal parameters of the visual sensor 4 include lens distortion, a focal length, etc. Examples of the external parameters of the visual sensor 4 include three-dimensional position and posture of the visual sensor 4 relative to the reference position of the robot 2 at the time of setting the reference position of the robot 2, three-dimensional position and posture of the visual sensor 4 relative to a position of the flange 5, etc.

The position and posture measurement unit 11 measures three-dimensional position and posture of the measurement target 7 using the results of image processing by the image processing unit 21. Specifically, the position and posture measurement unit 11 determines the three-dimensional position and posture of the measurement target 7 relative to the reference position of the robot 2 at the time of imaging, from the three-dimensional position and posture of the visual sensor 4 relative to the reference position of the robot 2 at the time of imaging (i.e., the current position and posture of the visual sensor 4) and the three-dimensional position and posture of the measurement target 7 relative to the visual sensor 4 obtained by the image processing unit 21.

The three-dimensional position and position of the visual sensor 4 relative to the reference position of the robot 2 at the time of imaging are obtained in the following manner. Since the visual sensor 4 of the present embodiment is a hand camera or the like, when the robot 2 moves, the position of the visual sensor 4 also changes in conjunction with the robot 2. Therefore, after the visual sensor 4 is attached, three-dimensional position and posture of the visual sensor 4 relative to the flange 5, which is not changed in position by the motion of the robot 2, are first acquired from the calibration data stored in the calibration data storage unit 22. In addition, three-dimensional position and posture of the flange 5 relative to the reference position of the robot 2 at the time of imaging, which are constantly able to be acquired from the robot control device 10 that generates a motion command for the robot 2, are acquired. Thereafter, based on the acquired three-dimensional position and posture of the visual sensor 4 relative to the flange 5 and the acquired three-dimensional position and posture of the flange 5 relative to the reference position of the robot 2 at the time of imaging, the three-dimensional position and posture of the visual sensor 4 relative to the reference position of the robot 2 at the time of imaging is calculated.

The imaging position correction unit 12 causes the position and posture moving unit 14, which will be described later, to move the visual sensor 4, by using the three-dimensional position and posture of the measurement target 7 measured by the position and posture measurement unit 11, and thereafter, sequentially causes the image processing unit 21 to perform the image processing and the position and posture measurement unit 11 to perform the measurement. The imaging position correction unit 12 performs, at least once, correction processing that includes moving the visual sensor 4, processing a captured image, and measuring three-dimensional position and posture, as described above.

It is preferable for the imaging position correction unit 12 to perform the above-described correction processing after causing the robot 2 to perform motion to be at a robot position where the visual sensor 4 approaches a position of the visual sensor 4 viewed from the measurement target 7 at the time of setting the reference position.

The correction processing by the imaging position correction unit 12 brings the relative position of the current imaging position and the measurement target 7 close to the relative position of the imaging position and the measurement target 7 at the time of setting the reference position of the robot 2. As a result, variation is reduced in measurement of the three-dimensional position and posture of the measurement target 7 performed by the position and posture measurement unit 11. That is, the conventional technique has a disadvantage that the three-dimensional position and posture of a measurement target obtained from captured images vary widely, and that there is a large correction error when a large difference exists between the position of the measurement target and a position to be corrected, whereas the present embodiment is capable of overcoming the disadvantage of the conventional technique. Therefore, the present embodiment can be suitably used in applications in which accurate motion such as mounting a workpiece is required.

The imaging position correction termination unit 13 determines whether or not to terminate the correction processing by the imaging position correction unit 12. The imaging position correction termination unit 13 of the present embodiment determines whether or not to terminate the correction processing depending on whether or not the imaging position correction unit 12 has performed the correction processing a predetermined number of times. The predetermined number of times is set to three, for example.

Specifically, when determining that the imaging position correction unit 12 has not yet performed the correction processing the predetermined number of times and that the correction processing is not to be terminated, the imaging position correction termination unit 13 causes the imaging position correction unit 12 to perform the correction processing again.

When determining that the imaging position correction unit 12 has performed the correction processing the predetermined number of times and that the correction processing is to be terminate, the imaging position correction termination unit 13 adopts, as the three-dimensional position and posture of the measurement target 7 for use in control of the robot 2, the three-dimensional position and posture of the measurement target 7 obtained through the final measurement or a halfway measurement by the position and posture measurement unit 11.

The three-dimensional position and posture of the measurement target 7 relative to the reference position of the robot 2 that have been obtained through the final measurement by the position and posture measurement unit 11 in the correction processing is accurate three-dimensional position and posture with reduced variation in measurement. Therefore, using the three-dimensional position and posture of the measurement target 7 relative to the reference position of the robot 2 adopted by the imaging position correction termination unit 13 makes it possible to accurately control the motion of the robot 2.

In a case where the visual sensor 4 is moved in an extremely small movement amount in the correction processing (for example, where the movement amount is smaller than a predetermined movement amount threshold), the accuracy of the movement of the robot 2 itself has a greater influence on a correction error. In this case, the correction error may be reduced by adopting, for example, the three-dimensional position and posture measured immediately before the final measurement, among the three-dimensional positions and postures of the measurement target 7 measured in the middle of the correction processing.

For example, by using the three-dimensional position and posture of the measurement target 7 relative to the reference position of the robot 2 adopted by the imaging position correction termination unit 13, it is possible to control the motion of the robot 2 with respect to an object having the measurement target 7 attached, and it is also possible to set a coordinate system for use in control of the robot 2. In this case, a movement amount of the set coordinate system is obtained by moving and rotating the set coordinate system itself until it coincides a reference coordinate system at a reference position, and the obtained movement amount is defined as an amount of deviation, i.e., a correction amount, based on which the motion of the robot 2 can be corrected. In addition, the three-dimensional position and posture of the measurement target 7 relative to the reference position of the robot 2 adopted by the imaging position correction termination unit 13 can be used for a coordinate system or the like for use in setting a teaching position for the robot 2. In the example illustrated in FIG. 1, the measurement target 7 is placed on a table T, and in this case, a coordinate system for use in the control of the robot 2 is set at the measurement target 7 on the table T.

The position and posture moving unit 14 moves the three-dimensional position and posture of the visual sensor 4. Specifically, the position and posture moving unit 14 moves the three-dimensional position and posture of the visual sensor 4 by controlling the motion of the robot 2. The imaging position correction unit 12 described above performs the correction processing by causing the position and posture moving unit 14 to move the visual sensor 4.

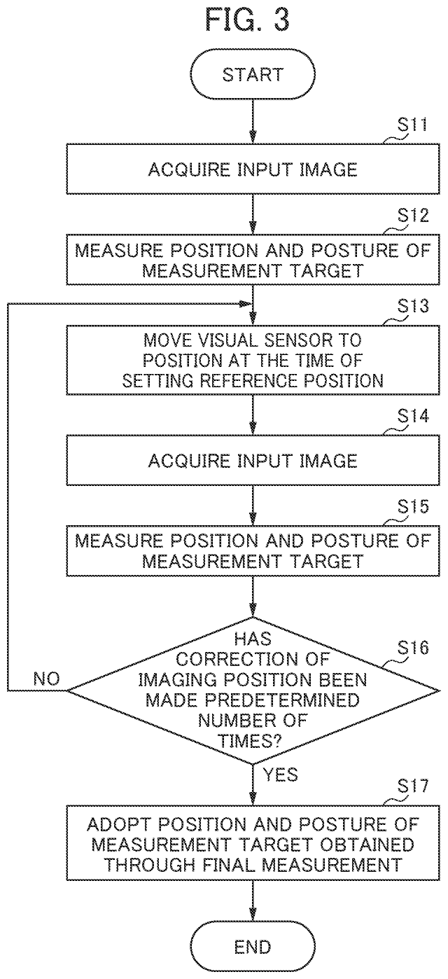

The processing that is performed by the position and posture measurement system 1 according to the first embodiment having the above-described configuration will be described in detail with reference to FIG. 3. FIG. 3 is a flowchart illustrating a procedure of the processing that is performed by the position and posture measurement system 1 according to the first embodiment.

First, in Step S11, an input image is acquired. Specifically, the visual sensor 4 captures an image of the measurement target 7, so that the input image is acquired by the image acquisition unit 23. Thereafter, the processing proceeds to Step S12.

Next, in Step S12, three-dimensional position and posture of the measurement target 7 are measured. Specifically, the position and posture measurement unit 11 measures the three-dimensional position and posture of the measurement target 7 using results of the image processing on the input image performed by the image processing unit 21. More specifically, the position and posture measurement unit 11 calculates the three-dimensional position and posture of the measurement target 7 relative to a reference position of the robot 2 at the time of imaging, from three-dimensional position and posture of the visual sensor 4 relative to the reference position of the robot 2 at the time of imaging and three-dimensional position and posture of the measurement target 7 relative to the visual sensor 4 obtained by the image processing unit 21. Thereafter, the processing proceeds to Step S13.

Next, in Step S13, the visual sensor 4 is moved to a position where the visual sensor 4 was present at the time of setting the reference position of the robot 2. Specifically, by using the three-dimensional position and posture of the measurement target 7 measured by the position and posture measurement unit 11, the imaging position correction unit 12 causes the robot 2 to perform motion so that the visual sensor 4 is moved to the position where the visual sensor 4 was present at the time of setting the reference position of the robot 2. Thereafter, the processing proceeds to Step S14.

Next, in Step S14, an input image is acquired. Specifically, the visual sensor 4 that has been moved in Step S13 newly captures an image of the measurement target 7, so that the input image is acquired by the image acquisition unit 23. Thereafter, the processing proceeds to Step S15.

Next, in Step S15, three-dimensional position and posture of the measurement target 7 are measured. Specifically, the position and posture measurement unit 11 measures the three-dimensional position and posture of the measurement target 7 using results of the image processing that the image processing unit 21 has performed on the input image of the measurement target 7, which has been captured in Step S14 by the visual sensor 4 moved in Step S13. The position and posture measurement unit 11 measures the three-dimensional position and posture of the measurement target 7 in the same manner as in Step S12. Thereafter, the processing proceeds to Step S16.

Next, in Step S16, it is determined whether or not correction has been made to the imaging position a predetermined number of times, for example, three times. When the determination result is NO, the processing returns to Step S13, and the imaging position correction unit 12 again performs the correction processing, which includes moving the visual sensor 4, image processing a captured image, and measuring three-dimensional position and posture. If the determination result is YES, the processing proceeds to Step S17.

Next, in Step S17, the three-dimensional position and posture of the measurement target 7 obtained through the final measurement by the position and posture measurement unit 11 are adopted as the three-dimensional position and posture of the measurement target 7 for use in control of the motion of the robot 2 with respect to an object having the measurement target 7 attached. Thereafter, the process ends.

In the example illustrated in the flowchart of FIG. 3, the finally-measured position and posture of the measurement target are adopted in Step S17. However, as described above, in the case where the visual sensor 4 is moved in an extremely small movement amount in the correction processing, for example, the three-dimensional position and posture measured immediately before the final measurement may be adopted, from the viewpoint of influence of the accuracy of movement of the robot 2 itself on the correction error.

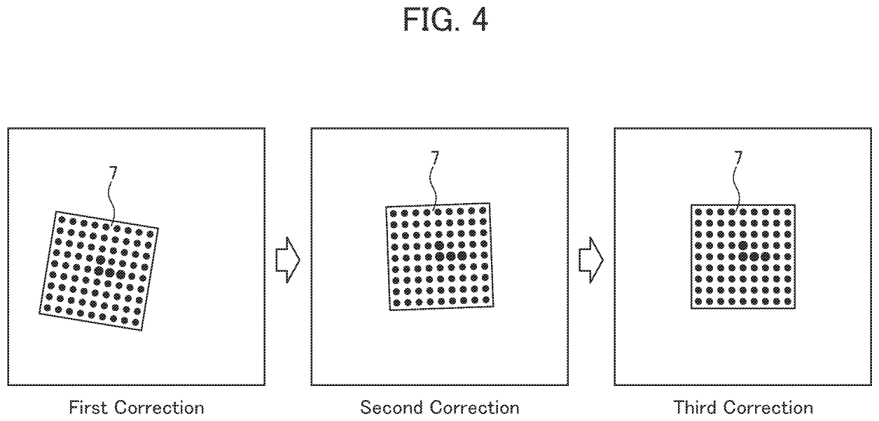

FIG. 4 is a diagram illustrating changes in input images in a case where an imaging position is moved. FIG. 4 illustrates the changes in the input images in a case where the imaging position correction unit 12 has repeatedly performed the correction processing three times. FIG. 4 illustrates an example in which a calibration jig is used as the measurement target 7.

Here, the calibration jig will be described in detail. As the calibration jig, a known calibration jig that can be used for calibration of the visual sensor 4 can be employed. The calibration jig has a dot pattern arranged on a plane, and the visual sensor 4 captures an image of the dot pattern whereby information necessary for calibration of the visual sensor 4 is acquired. The dot pattern satisfies three requirements: (1) an interval between the lattice points of the dot pattern is known; (2) a certain number or more of lattice points are present; and (3) each lattice point is uniquely identifiable. The calibration jig is not limited to the jig illustrated in FIG. 4, which has a feature such as a predetermined dot pattern arranged in a two-dimensional plane, but may be a jig having features arranged in a three-dimensional shape, or may be a jig from which three-dimensional positional information including positional information in a height direction (Z direction) in addition to two-dimensional positional information (in the X direction and Y direction) can be obtained. The calibration jig may be the same as or different from the calibration jig used at the time of calibration of the visual sensor 4. In order to calculate the three-dimensional position and posture of the dot pattern relative to the visual sensor 4 from an image of the dot pattern captured by the visual sensor 4, the internal parameters contained in the calibration data are used.

As illustrated in FIG. 4, when the imaging position correction unit 12 performs the correction processing, the relative position of the imaging position and the measurement target 7 changes. It is appreciated that the three-dimensional position and posture of the measurement target 7 gradually change in the input images. As can be appreciated, performing the correction processing plural times makes the movement amount of the visual sensor 4 approach 0, and the position of the measurement target 7 in the input image converges to the center of the input image.

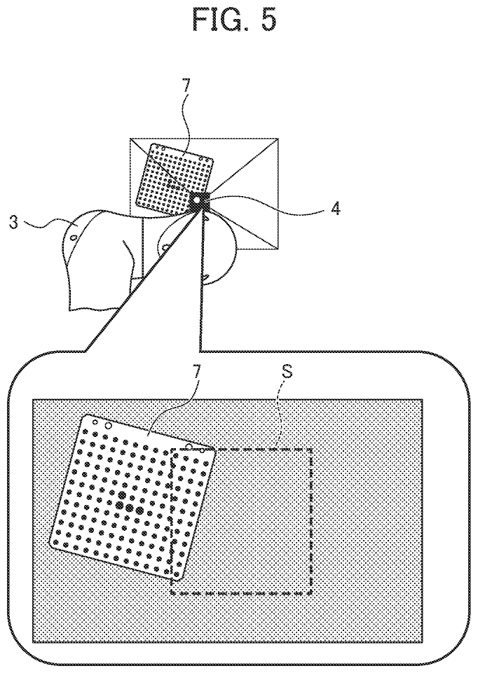

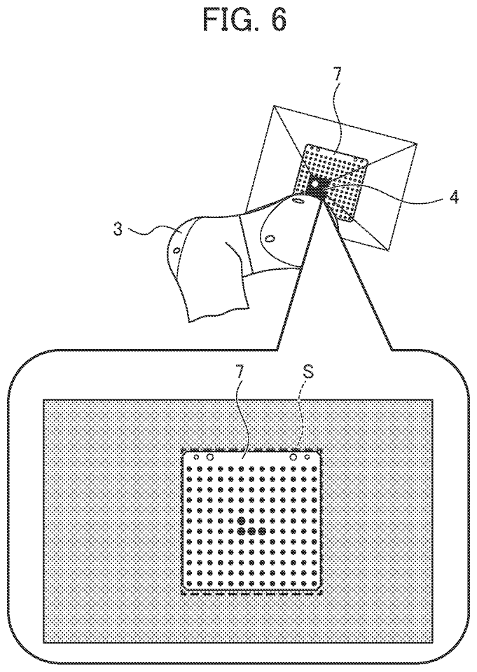

FIG. 5 is a diagram illustrating a position of the measurement target 7 before movement of an imaging position and a position S of the measurement target 7 at the time of setting a reference position. FIG. 6 is a diagram illustrating a position of the measurement target 7 after the movement of the imaging position and the position S of the measurement target 7 at the time of setting the reference position. As can be seen from FIGS. 5 and 6, as a result of the correction processing performed by the imaging position correction unit 12, the position of the measurement target 7 in the input image converges to the position S of the measurement target 7 at the time of setting the reference position, the position S being located at the center of the input image. In other words, the current relative position of the imaging position and the measurement target 7 is brought close to the relative position of the imaging position and the measurement target 7 at the time of setting the reference position of the robot 2, as can be appreciated from the figures.

The position and posture measurement system 1 according to the first embodiment exerts the following effects.

In the position and posture measurement system 1 according to the present embodiment includes the imaging position correction unit 12, which performs the correction processing at least once, and the correction processing includes causing, by using the three-dimensional position and posture of the measurement target 7 measured by the position and posture measurement unit 11, the position and posture moving unit 14 to make the robot 2 perform motion to be at a position of the robot 2 where the visual sensor 4 comes close to a position of the visual sensor 4 viewed from the measurement target 7 at the time of setting the reference position, followed by sequentially causing the image processing unit 21 to perform image processing, and the position and posture measurement unit 11 to perform measurement. The position and posture measurement system 1 according to the present embodiment includes the imaging position correction termination unit 13, which causes the correction processing to be performed again when determining that the imaging position correction unit 12 has not yet performed the correction processing a predetermined number of times and that the correction processing is not be terminated, and which adopts, as the three-dimensional position and posture of the measurement target 7 for use in control of the robot 2, three-dimensional position and posture of the measurement target 7 obtained through the final measurement or a halfway measurement by the position and posture measurement unit 11 when determining that the imaging position correction unit 12 has performed the correction processing the predetermined number of times and that the correction processing is to be terminated.

Due to this feature, the correction processing by the imaging position correction unit 12 brings the current relative position of the imaging position and the measurement target 7 close to the relative position of the imaging position and the measurement target 7 at the time of setting the reference position of the robot 2. Thus, according to the present embodiment, since variation in the measurement of the three-dimensional position and posture of the measurement target 7 by the position and posture measurement unit 11 can be reduced, the three-dimensional position and posture of the measurement target 7 can be accurately measured with a simpler teaching and within a shorter measurement time in comparison with the known art. Consequently, the three-dimensional position and posture of the measurement target 7 measured according to the present embodiment can be used for an operation that requires the robot 2 to perform precise motion.

### Modification of First Embodiment

The position and posture measurement system according to a modification of the first embodiment has the same configuration as that of the first embodiment except that the configuration of an imaging position correction termination unit 13 of the modification is different from that in the position and posture measurement system 1 according to the first embodiment. Specifically, the imaging position correction termination unit according to the modification of the first embodiment determines whether or not to terminate the correction processing depending on a movement amount in which the visual sensor 4 has been moved in correction processing by the imaging position correction unit 12. More specifically, the imaging position correction termination unit according to the modification of the first embodiment determines that the correction processing is not to be terminated when the movement amount in which the visual sensor 4 has been moved by the imaging position correction unit 12 is a predetermined threshold value or more, and determines that the correction processing is to be terminated when the movement amount in which the visual sensor 4 has been moved by the imaging position correction unit 12 is smaller than the predetermined threshold value.

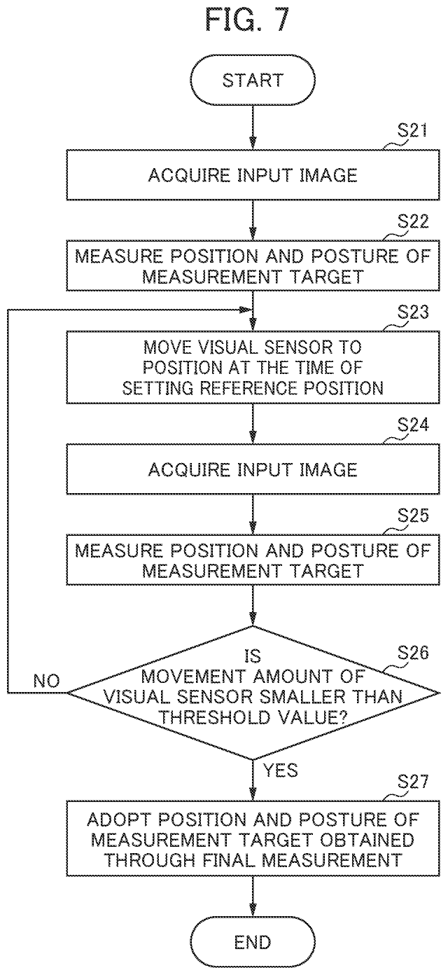

FIG. 7 is a flowchart illustrating the procedure of the processing that is performed by the position and posture measurement system according to the modification of the first embodiment. Steps S21 to S25 in FIG. 7 are the same as Steps S11 to S15 of the first embodiment.

In Step S26, it is determined whether or not the movement amount of the visual sensor 4 is smaller than the predetermined threshold value. Specifically, it is determined whether or not the movement amount in which the visual sensor 4 has been moved in Step S23 is smaller than the predetermined threshold value. The movement amount of the visual sensor 4 is obtained from a movement amount of the robot 2. When the determination result is NO, the processing returns to Step S23, and the imaging position correction unit 12 again performs the correction processing, which includes moving the visual sensor 4, processing a captured image, and measuring three-dimensional position and posture. When the determination result is YES, the processing proceeds to Step S27.

Next, in Step S27, similarly to Step S17 of the first embodiment, the three-dimensional position and posture of the measurement target 7 obtained through the final measurement by the position and posture measurement unit 11 is adopted as the three-dimensional position and posture of the measurement target 7 for use in control of the robot 2. Thereafter, the present processing ends.

In the example illustrated in the flowchart of FIG. 7, the finally-measured position and posture of the measurement target is adopted in Step S27. However, as in the first embodiment, in a case where the visual sensor 4 is moved in an extremely small movement amount in the correction processing, for example, the three-dimensional position and posture measured immediately before the final measurement may be adopted, from the viewpoint of influence of the accuracy of movement of the robot 2 itself on the correction error.

In a case where the movement amount of the visual sensor 4 does not become smaller than the predetermined threshold value, an alarm may be issued to notify the situation to the user. In this case, it is suitable to set in advance the upper limit of the number of times of correction processing.

The position and posture measurement system according to the modification of the first embodiment exerts the same effects as those exerted by the position and posture measurement system 1 according to the first embodiment. In addition, according to this modification, in a case where the visual sensor 4 is moved in a small movement amount from the first correction processing, the correction processing can be completed within a shorter time than in the first embodiment.

### Second Embodiment

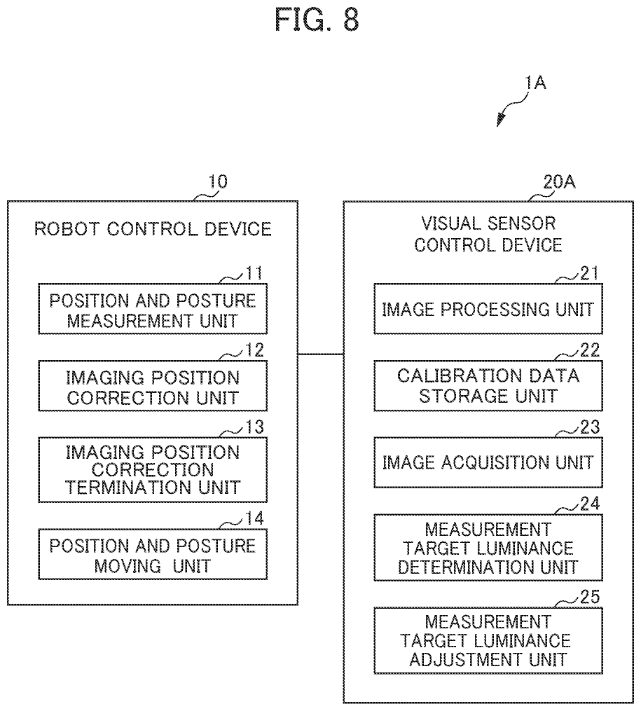

FIG. 8 is a block diagram illustrating a configuration of a position and posture measurement system 1A according to a second embodiment. As illustrated in FIG. 8, the position and posture measurement system 1A according to the second embodiment has the same configuration as that of the first embodiment except that the configuration of a visual sensor control device 20A is different from that in the position and posture measurement system 1 according to the first embodiment. Specifically, in the position and posture measurement system 1A according to the second embodiment, the visual sensor control device 20A further includes a measurement target luminance determination unit 24 and a measurement target luminance adjustment unit 25.

The measurement target luminance determination unit 24 measures luminance of the measurement target 7 in a captured image processed by the image processing unit 21. The measurement target luminance determination unit 24 determines whether or not a difference between the measured luminance and luminance of the measurement target 7 in an image captured at the time of setting a reference position of the robot 2 is greater than a predetermined first threshold value.

When the measurement target luminance determination unit 24 determines that the difference in luminance is greater than the predetermined first threshold value, the measurement target luminance adjustment unit 25 makes adjustment such that the luminance of the measurement target 7 approaches the luminance at the time of setting the reference position of the robot 2. Specifically, the measurement target luminance adjustment unit 25 changes an exposure condition of the visual sensor 4 or combines a plurality of images captured under different exposure conditions of the visual sensor 4 such that the luminance of the measurement target 7 approaches the luminance at the time of setting the reference position of the robot 2.

The measurement target luminance determination unit 24 and the measurement target luminance adjustment unit 25 perform the respective processing concurrently with the correction processing by the imaging position correction unit 12. Specifically, after the visual sensor 4 is moved, the measurement target luminance determination unit 24 and the measurement target luminance adjustment unit 25 perform the respective processing in parallel with processing of a captured image and measurement of three-dimensional position and posture.

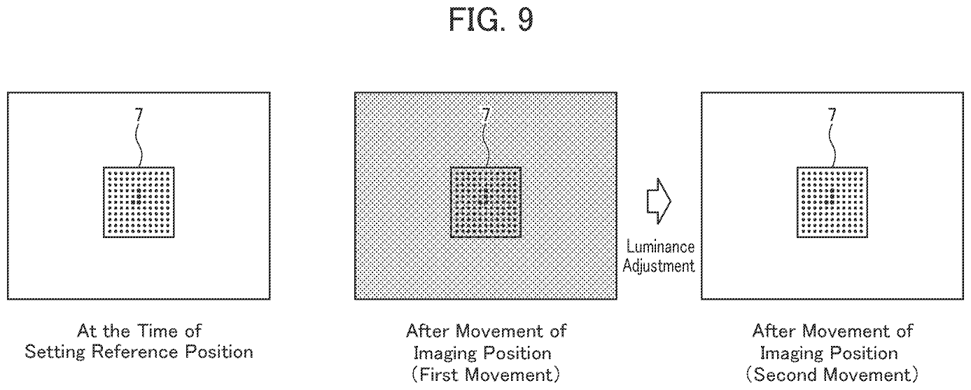

FIG. 9 is a diagram illustrating changes in input images in a case where an imaging position is moved and the luminance is adjusted. In the example illustrated in FIG. 9, the luminance of the measurement target 7 in the input image after the first movement of the imaging position is lower than the luminance of the measurement target 7 in the input image at the time of setting the reference position, and the difference in luminance between the input images is greater than the first threshold value. Therefore, the measurement target luminance adjustment unit 25 changes the exposure condition concurrently with the second movement of the imaging position, thereby adjusting the luminance. It is appreciated that, as a result of the change of the exposure condition, the luminance of the measurement target 7 in the input image after the second movement of the imaging position is equivalent to the luminance of the measurement target 7 in the input image at the time of setting the reference position.

According to the position and posture measurement system 1A of the second embodiment, when an image is captured at an imaging position that has been moved, the exposure condition of the visual sensor 4 is automatically adjusted so that the luminance, i.e., the brightness of the measurement target 7 in the image that is captured approaches the brightness at the time of setting the reference position. Alternatively, in this case, a composite image is produced by combining a plurality of captured images that differ in luminance. The images are combined by conventional HDR composition or the like. Thus, the brightness of the measurement target 7 in the image captured at the time of setting the reference position and the brightness of the measurement target 7 in the image captured after the movement of the visual sensor 4 can be made close to each other, thereby making it possible to suppress an increase in a measurement error of the three-dimensional position and posture of the measurement target 7, which can be caused by a difference in brightness of the measurement target 7 from the time of setting the reference position.

### Third Embodiment

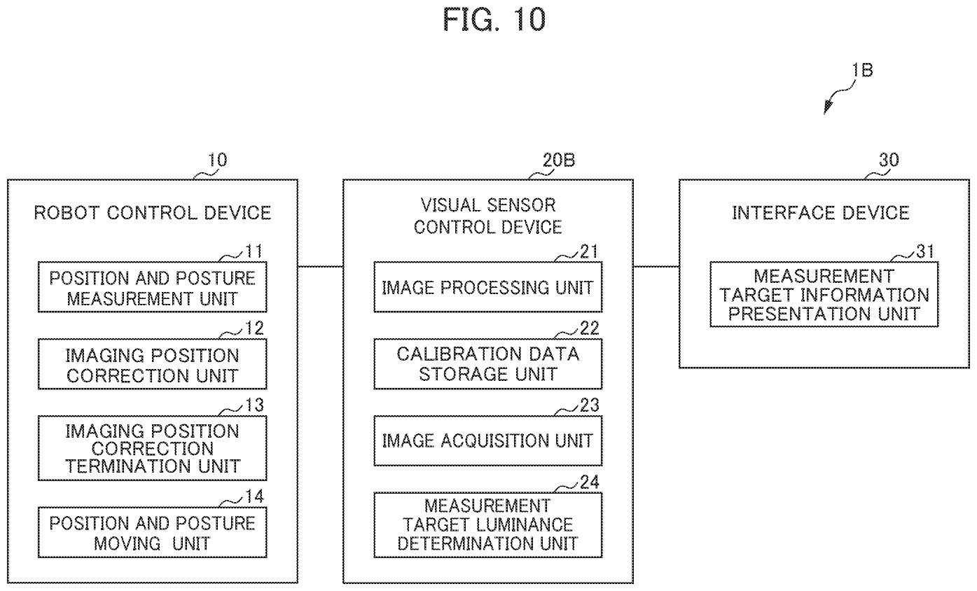

FIG. 10 is a block diagram illustrating a configuration of a position and posture measurement system 1B according to a third embodiment. As illustrated in FIG. 10, the position and posture measurement system 1B according to the third embodiment has the same configuration as that of the position and posture measurement system 1 of the first embodiment except that the configuration of a visual sensor control device 20B is different and an interface device 30 is further provided.

Specifically, in the position and posture measurement system 1B according to the third embodiment, the visual sensor control device 20B further includes a measurement target luminance determination unit 24. The measurement target luminance determination unit 24 has basically the same configuration as that of the second embodiment.

The measurement target luminance determination unit 24 measures luminance of the measurement target 7 in a captured image processed by the image processing unit 21. The measurement target luminance determination unit 24 determines whether or not a difference between the measured luminance and luminance of the measurement target 7 in an image captured at the time of setting a reference position of the robot 2 is greater than a predetermined second threshold value. Here, the predetermined second threshold value may be the same as or different from the first threshold value.

The interface device 30 includes a measurement target information presentation unit 31. When the measurement target luminance determination unit 24 determines that the difference in luminance is greater than the predetermined second threshold value, the measurement target information presentation unit 31 presents to the user information that the luminance of the measurement target 7 is significantly different from luminance at the time of setting the reference position of the robot 2. For example, the measurement target information presentation unit 31 may display, on a display screen of the interface device 30, the following pop-up message: “The brightness of the measurement target (marker) significantly differs from brightness at the time of setting the reference position. It is recommended to change the lighting environment”.

It should be noted that the measurement target information presentation unit 31 does not necessarily have to be provided to the interface device 30. For example, the measurement target information presentation unit may be provided in a display unit of the visual sensor control device 20B, instead of the interface device 30.

The measurement target luminance determination unit 24 and the measurement target information presentation unit 31 perform the respective processing concurrently with the correction processing by the imaging position correction unit 12. Specifically, after the visual sensor 4 is moved, the measurement target luminance determination unit 24 and the measurement target information presentation unit 31 perform the respective processing in parallel with processing of a captured image and measurement of three-dimensional position and posture.

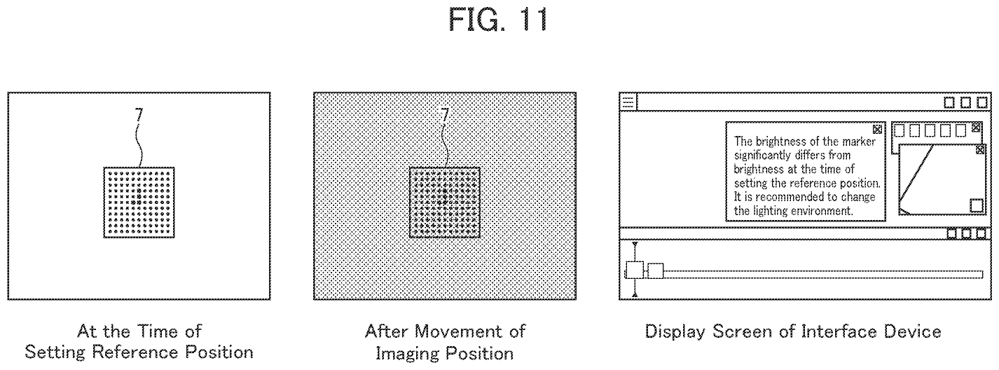

FIG. 11 is a diagram illustrating the display screen of the interface device 30 in a case where a difference in luminance of the measurement target between images before and after the movement of the imaging position is determined to be greater than the second threshold value. In the example illustrated in FIG. 11, the luminance of the measurement target 7 in the input image after the movement of the imaging position is lower than the luminance of the measurement target 7 in the input image at the time of setting the reference position, and the difference in luminance between the input images is greater than the second threshold value. As illustrated, the measurement target information presentation unit 31 displays, on the display screen of the interface device 30, the pop-up message: “The brightness of the marker significantly differs from brightness at the time of setting the reference position. It is recommended to change the lighting environment”.

According to the position and posture measurement system 1B of the third embodiment, when the brightness of the measurement target 7 significantly differs from that at the time of setting the reference position, the corresponding information can be presented to the user. This feature makes it possible to prompt the user not only to change the lighting environment, but also to manually change the exposure condition of the visual sensor 4, thereby enabling suppression of an increase in the measurement error of the three-dimensional position and posture of the measurement target 7, which can be caused by a change in the lighting condition due to an external factor.

### Fourth Embodiment

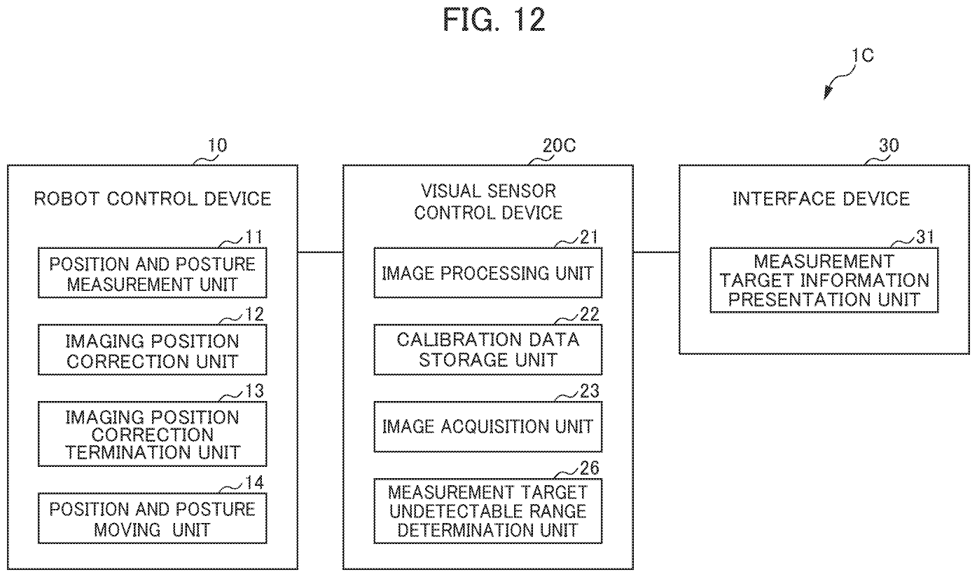

FIG. 12 is a block diagram illustrating a configuration of a position and posture measurement system 1C according to a fourth embodiment. As illustrated in FIG. 12, the position and posture measurement system 1C according to the fourth embodiment has the same configuration as that of the position and posture measurement system 1 of the first embodiment except that the configuration of a visual sensor control device 20C is different and an interface device 30 is further provided.

Specifically, in the position and posture measurement system 1C according to the fourth embodiment, the visual sensor control device 20C further includes a measurement target undetectable range determination unit 26. The measurement target undetectable range determination unit 26 measures an undetectable range of the measurement target 7 in a captured image processed by the image processing unit 21, and determines whether or not the measurement value is greater than a predetermined undetectability threshold value.

Here, the undetectable range of the measurement target 7 in a captured image refers to, for example, a range in which the measurement target 7 cannot be detected due to dust, some shielding object, reflection or halation caused by a lighting member or the like provided to the visual sensor 4. The undetectable range of the measurement target 7 can be measured, for example, from a ratio of the area of the undetectable range of the measurement target 7 to the entire area of the captured image.

The interface device 30 includes a measurement target information presentation unit 31. When the measurement target undetectable range determination unit 26 determines that the measurement value of the undetectable range is greater than the predetermined undetectability threshold value, the measurement target information presentation unit 31 presents to the user information that the undetectable range is large. For example, the measurement target information presentation unit 31 may display, on a display screen of the interface device 30, the following pop-up message: “A large range of the measurement target (marker) is undetectable. Please check whether to change the lighting environment or whether the measurement target is hidden by some shielding object”.

It should be noted that the measurement target information presentation unit 31 does not necessarily have to be provided to the interface device 30. For example, the measurement target information presentation unit may be provided to a display unit of the visual sensor control device 20C, instead of the interface device 30.

The measurement target undetectable range determination unit 26 and the measurement target information presentation unit 31 perform the respective processing concurrently with the correction processing by the imaging position correction unit 12. Specifically, after the visual sensor 4 is moved, the measurement target undetectable range determination unit 26 and the measurement target information presentation unit 31 perform the respective processing in parallel with processing of a captured image and measurement of three-dimensional position and posture.

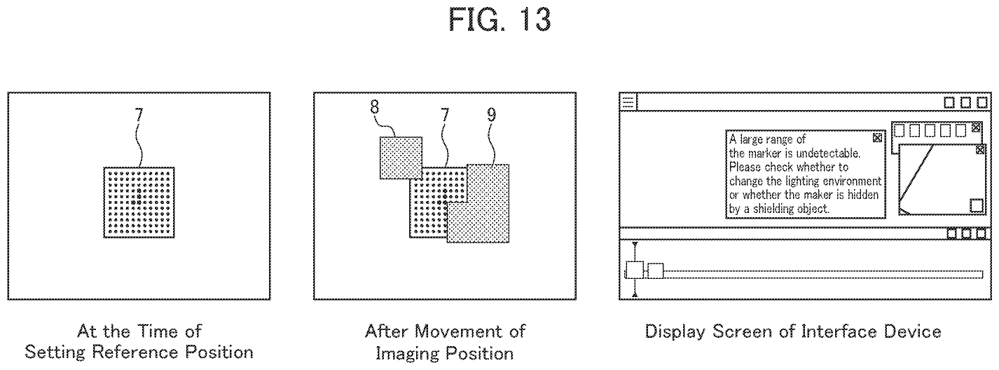

FIG. 13 is a diagram illustrating the display screen of the interface device 30 in a case where the undetectable range of the measurement target 7 in the input image after movement of the imaging position is determined to be greater than the undetectability threshold value. In the example illustrated in FIG. 13, shielding objects 8 and 9 overlap with the measurement target 7 in the input image captured after the movement of the imaging position, and the undetectable range is greater than the undetectability threshold value. As illustrated, the measurement target information presentation unit 31 displays, on the display screen of the interface device 30, the pop-up message: “A large range of the marker is undetectable. Please check whether to change the lighting environment or whether the marker is hidden by a shielding object”.

According to the fourth embodiment, in a case where part of the measurement target 7 is hidden by an external factor such as dust, some shielding object, etc. or in a case where the measurement target 7 cannot be detected in a captured image due to reflection, halation, or the like caused by lighting, the position and posture measurement system 1C measures the undetectable range, and presents information for prompting the user to pay attention in the case where the undetectable range is larger than the predetermined undetectability threshold value. This feature make it possible to prompt the user not only to change the lighting environment so as to reduce the area of the undetectable range of the measurement target 7, but also to remove the external factor. Thus, the present embodiment enables further suppression of an increase in the measurement error of the three-dimensional position and posture of the measurement target 7, which can be caused by an increase in the area of the undetectable range of the measurement target 7.

It should be noted that the present disclosure is not limited to the above-described embodiments, and modifications and improvements to the extent that the object of the present disclosure can be achieved are encompassed in the scope of the present disclosure.

For example, the position and posture measurement system of the present disclosure is applicable to a system which is different from those of the embodiments described above, and in which a robot 2 holds a measurement target 7, and a visual sensor 4 is attached to a machine tool. In this case, the imaging position correction unit 12 performs correction processing by causing the position and posture moving unit 14 to move the measurement target 7. The imaging position correction termination unit 13 determines whether or not to terminate the correction processing based on a movement amount in which the measurement target 7 has been moved.

For example, a visual sensor 4 may be attached to a hand of a different robot, and the visual sensor 4 and two robots may be employed to implement the position and posture measurement system of the present disclosure.

The imaging position correction unit 12 of the above embodiments may be configured to cause the visual sensor 4 or the measurement target 7 to move such that the visual sensor 4 or the measurement target 7 approaches first position and posture indicating a reference posture of the measurement target 7 (i.e., the position and posture at the time of setting a position serving as a reference based on which correction is made), and thereafter, to perform, at least once, the above-described correction processing based on the image processing by the image processing unit 21 and the measurement by the position and posture measuring unit 11. In this case, the imaging position correction termination unit 13 of the above embodiments may be configured to determine whether or not to terminate the correction processing based on second position and posture of the measurement target 7 measured by the position and posture measurement unit 11 through the correction processing performed by the imaging position correction unit 12 (i.e., any of the positions and postures measured by the position and posture measurement unit 11 through the correction processing).

### EXPLANATION OF REFERENCE NUMERALS

1, 1A, 1B, 1C: Position and posture measurement system
2: Robot
3: Robot arm
4: Visual sensor
5: Flange
6: End tool
7: Measurement target
10: Robot control device
11: Position and posture measurement unit
12: Imaging position correction unit
13: Imaging position correction termination unit
14: Position and posture moving unit
20, 20A, 20B, 20C: Visual sensor control device
21: Image processing unit
22: Calibration data storage unit
23: Image acquisition unit
24: Measurement target luminance determination unit
25: Measurement target luminance adjustment unit
26: Measurement target undetectable range determination unit
30: Interface device
31: Measurement target information presentation unit
100: Robot System
S: Position at the time of setting reference position
T: Table

1. A position and posture measurement system for measuring three-dimensional position and posture of a measurement target for use in control of a robot, the position and posture measurement system comprising:
a visual sensor subjected to calibration;
a position and posture moving unit that is capable of moving three-dimensional position and posture of the measurement target or three-dimensional position and posture of the visual sensor;
a calibration data storage unit that stores in advance calibration data obtained during the calibration of the visual sensor;
an image processing unit that processes a captured image of the measurement target, the captured image being obtained by imaging the measurement target by the visual sensor;
a position and posture measurement unit that measures three-dimensional position and posture of the measurement target by using a result of image processing by the image processing unit;
an imaging position correction unit that performs correction processing at least once, the correction processing comprising causing the position and posture moving unit to move the visual sensor or the measurement target by using the three-dimensional position and posture of the measurement target measured by the position and posture measurement unit, followed by sequentially causing the image processing unit to perform image processing, and the position and posture measurement unit to perform measurement; and
an imaging position correction termination unit that determines whether or not to terminate the correction processing by the imaging position correction unit, wherein when determining that the correction processing is not to be terminated, the imaging position correction termination unit causes the correction processing to be performed again, and when determining that the correction processing is to be terminated, the imaging position correction termination unit adopts, as the three-dimensional position and posture of the measurement target for use in control of the robot, three-dimensional position and posture of the measurement target obtained through a final measurement or a halfway measurement by the position and posture measurement unit.

2. The position and posture measurement system according to claim 1, wherein
the imaging position correction unit performs the correction processing after causing the robot to perform motion to be at a robot position where the visual sensor approaches a position at which the visual sensor is present as viewed from the measurement target when a position serving as a reference based on which correction is made is set.

3. The position and posture measurement system according to claim 1, wherein
the imaging position correction termination unit determines that the correction processing is to be terminated in a case where the imaging position correction unit has performed the correction processing a predetermined number of times.

4. The position and posture measurement system according to claim 1, wherein
the imaging position correction termination unit determines that the correction processing is to be terminated when a movement amount in which the visual sensor or the measurement target has been caused to move by the imaging position correction unit is smaller than a predetermined threshold value.

5. The position and posture measurement system according to claim 1, further comprising:
a measurement target luminance determination unit that measures luminance of the measurement target in a captured image processed by the image processing unit, and determines whether or not a difference in luminance between the luminance measured and luminance of the measurement target in an image captured at the time of setting a reference position of the robot is greater than a predetermined first threshold value; and
a measurement target luminance adjustment unit that makes adjustment such that the luminance of the measurement target approaches the luminance at the time of setting the reference position of the robot in a case where the measurement target luminance determination unit determines that the difference in luminance is greater than the predetermined first threshold value.

6. The position and posture measurement system according to claim 1, further comprising:
a measurement target luminance determination unit that measures luminance of the measurement target in a captured image processed by the image processing unit, and determines whether or not a difference in luminance between the luminance measured and luminance of the measurement target in an image captured at the time of setting a reference position of the robot is greater than a predetermined second threshold value; and
a measurement target information presentation unit that presents to a user information that the luminance of the measurement target is significantly different from the luminance at the time of setting the reference position of the robot in a case where the measurement target luminance determination unit determines that the difference in luminance is greater than the predetermined second threshold value.

7. The position and posture measurement system according to claim 1, further comprising:
a measurement target undetectable range determination unit that measures an undetectable range of the measurement target in a captured image processed by the image processing unit, and determines whether or not the undetectable range is greater than a predetermined undetectability threshold value; and
a measurement target information presentation unit that presents to a user information that the undetectable range is large in a case where the measurement target undetectable range determination unit determines that the undetectable range is greater than the predetermined undetectability threshold value.

8. A position and posture measurement system comprising:
a visual sensor subjected to calibration;
an image processing unit that processes a captured image of a measurement target, the captured image being obtained by imaging the measurement target by the visual sensor;
a position and posture measurement unit that measures position and posture of the measurement target by using a result of image processing by the image processing unit;
an imaging position correction unit that moves the visual sensor or the measurement target such that the visual sensor or the measurement target approaches first position and posture indicating a reference posture of the measurement target, and thereafter, performs, at least once, correction processing based on image processing by the image processing unit and measurement by the position and posture measuring unit; and
an imaging position correction termination unit that determines whether or not to terminate the correction processing based on second position and posture of the measurement target measured by the position and posture measurement unit through the correction processing by the imaging position correction unit.
